(19) United States
(12) Patent Application Publication
(10) Pub. No.: US 2019/0308360 A1
(43) Pub. Date: Oct. 10, 2019

(54) EXTRUSION PROCESS FOR COATING WIRE, AND WIRES MADE THEREFROM

(71) Applicant: SABIC GLOBAL TECHNOLOGIES B.V., BERGEN OP ZOOM (NL)

(72) Inventors: Chao Liu, Pudong (CN); Ying Na, Pudong (CN); Shuailei Ma, Mt. Vernon, IN (US); Yonglei Xu, Pudong (CN); Kapil Chandrakant Sheth, Mt. Vernon, IN (US); Shan Qin, Pudong (CN)

(21) Appl. No.: 16/463,106

(22) PCT Filed: Dec. 28, 2017
(86) PCT No.: PCT/IB2017/058457

§ 371 Date: May 22, 2019

Related U.S. Application Data
(60) Provisional application No. 62/440,185, filed on Dec. 29, 2016.

(51) Int. Cl. B29C 48/154; B29C 48/00; B29C 48/05; B29C 48/28; B29C 48/88

(52) U.S. Cl. CPC B29C 48/154; B29C 48/022; B29C 48/05; B29K 2101/12; B29C 48/911; B29C 48/919; B29C 48/0012; B29C 48/28

(57) ABSTRACT

A method of making a wire with multiple coating layers can comprise: preheating a wire to a temperature Tₚᵣₑₕₑₐₜ to form a pre-heated wire; using a first extruder to coat the pre-heated wire with the first coating material to form a first coated wire; passing the first coated wire to a second extruder without storing the first coated wire, coating the first coated wire with a second coating material to form a second coated wire; and cooling the second coated wire.

### BACKGROUND

Solid and foamed fluoropolymers (FP), such as fluorinated ethylene propylene (FEP), polyvinylidene fluoride (PVDF), ethylene chlorotrifluoroethylene (ECTFE), ethylene tetrafluoroethylene (ETFE), polytetrafluoroethylene (PTFE) and the like, are typically selected as the insulation materials for plenum cables. These materials, despite typically exhibiting good flame and smoke properties in cables, suffer from significant drawbacks.

Use of fluoropolymers in communication cables is the subject of concern in many countries. In the United States, for example, plenum rated communication cables constructed with plastic materials in the plenum spaces of buildings are regulated to meet rigorous fire safety test standards in accordance with the National Fire Protection Association standard NFPA 262 as outlined in NFPA 90A. Low smoke zero halogen (LSOH) material and polyolefin based insulations could not pass the required flame and smoke test for plenum rated cables according to NFPA 262. Solid and foamed fluoropolymers (FP) (FEP, PVDF, ECTFE, ETFE, PTFE etc.) are typically selected as the insulation materials as they meet such stringent flame and smoke requirements. However, fluoropolymers such as FEP have a high specific gravity (˜2.2). In addition, fluoropolymers exhibit undesired levels of corrosion to tool/die equipment and thus require special care during wire extrusion. Moreover, halogenated fluoropolymers emit high toxic and corrosive smoke during a fire event. There are significant concerns over the potential toxicity of FP such as FEP. In fact, the state of California has proposed some of these materials as potential human carcinogens. As such, a material solution meeting all the electrical, mechanical, flame and smoke requirements for insulation of plenum rated cables, that is more environmentally friendly, is needed.

Fluoropolymers are used for both single and dual wire coatings. Conventionally, dual wire coating processes include, coating the wire with a first coating, followed by cooling and coiling the single coated wire. The second coating layer is then applied to the single coating wire, followed by cooling and coiling, to form the dual coating wire. Such process is inefficient and costly due to the number of steps and time for cooling and coiling in between the coating applications. As such, more efficient methods of producing multicoating wires are needed.

### BRIEF DESCRIPTION OF THE DRAWINGS

Refer now to the figures, which are exemplary embodiments, and wherein the like elements are numbered alike.

FIG. 1 shows a traditional dual layer wire extrusion process.

FIG. 2 shows the dual wire extrusion process.

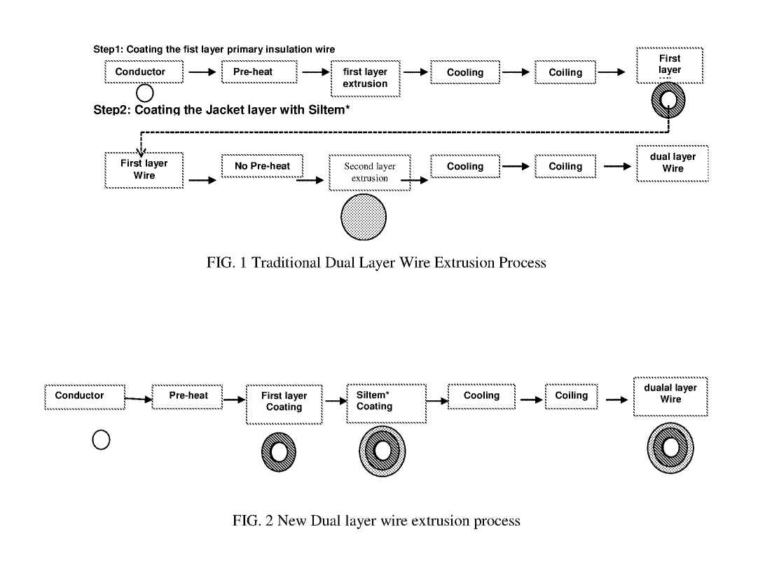

### DETAILED DESCRIPTION

The present method of producing a multiple coated wire includes a co-extrusion process of applying a second coating layer after applying a first coat layer to the wire. For example, the second (and optionally any subsequent) coating is applied before the coated wire is spooled. In other words, the coated wire moves from the application of the first coating (e.g. a foamed coating) to the application of a second coating, without storage of the coated wire between the application of the coatings. The process does not require cooling and coiling the wire after the application of the first coating layer before applying the second coating layer. Not only does this save cost and time by eliminating multiple steps, but the process is also advantageous because it utilizes the heat from the extrusion of the first coating layer during the application of the second coating layer, which improves adhesion between the first coating layer and the second coating layer. In addition, this process permits the use of engineering thermoplastic materials to realize a lower cost while still meeting the rigorous regulation standards.

In an example of the method, a wire is unwound from a spool and is heated prior to passing through a first extruder (e.g., through a tool in the crosshead of the first extruder) that applies a first coating layer to the wire. The wire can be pre-heated based upon the specific coating materials, e.g., to balance wire performance such as foaming rate and tensile elongation. For example, the wire can be heated to greater than or equal to 100° C., such as 125° C. to 220° C., or 150° C. to 180° C., or 160° C. to 180° C. From the first extruder the pre-heated, coated wire passes through a second extruder that applies a second coating layer to the wire such that the second coating layer is applied to the first coating layer. The pre-heated, coated wire passes from the first extruder without being cooled to room temperature, e.g. without being moved to a spool or other container. In other words, the pre-heated, coated wire travels directly to the second extruder, e.g. such that the preheating prior to the first extruder enhances adhesion of the second coating layer. During the process of coating a wire, the wire can be pulled by a retractor to continuously move the wire passing through the extruders. After the second extrusion, the wire can be cooled. The wire can be cooled (e.g., actively and/or passively), such as using at least one of a water bath, water spray, and air jet(s) after extrusion coating. The water can be from 5° C. to 60° C., for example the water can be room temperature, e.g., 23° C. to 25° C. After cooling, the coated wire can be wound onto a spool or like device, typically at a speed of 10 meters per minute (m/min) to 500 m/min.

The first coating layer on the wire can have a thickness of less than or equal to 0.60 millimeters (mm), for example, less than or equal to 0.40 mm, or less than or equal to 0.20 mm, or less than or equal to 0.15 mm, or less than or equal to 0.10 mm. The second coating layer on the wire can have a thickness of less than or equal to 0.60 mm, for example, less than or equal to 0.30 millimeters (mm), or less than or equal to 0.25 mm, or less than or equal to 0.15 mm. Optionally, the second coating layer can be thicker than the first coating layer.

The coatings described above can be applied to numerous different types of core, notably cord, wires, or cables (for simplicity, referred to as wire), that may or may not be conductive. For example, the wire can be copper, which may be nickel or tin coated or silver-plated, aluminum, typically copper-clad aluminum, silver or steel. For other purposes, non-metallic cores such as carbon fiber, polymeric, or ceramic cores, may be used. The cable may be single core or multi-core or may comprise a twisted pair of wires, a multi-strand core or a braid. Any of these cores may be coated with copper, nickel, tin or silver. Each strand of the wire can have a thickness of less than or equal to 1 mm, e.g., less than or equal to 0.80 mm, or 0.1 mm to 0.4 mm, or 0.20 mm to 0.30 mm.

The first coating layer and second coating layer can be independently selected from polycarbonates (PC), polyphenylene ether (PPE) elastomer blends, polyetherimide (PEI), polyethylene (PE), thermoplastic engineering elastomers (TPE), engineering thermoplastic (ETP) materials, and combinations thereof.

Engineering thermoplastic materials are used as the extruded insulation of plenum rated communication cables to replace fluoropolymers (FP) such as fluorinated ethylene propylene (FEP), ethylene chlorotrifluoroethylene (ECTF) and ethylene tetrafluoroethylene (ETFE). The extruded engineering thermoplastic insulation satisfies electrical requirements, mechanical performance requirements, processability requirements, and the flame and smoke requirements of plenum rated cables. Engineering thermoplastic insulation, with a lower specific gravity than FPs, offers a lower market price than FP. The engineering thermoplastic insulation is less corrosive to tool/die equipment during processing than FP and produces lower toxicity emissions during a fire event.

Traditionally, engineering thermoplastics have not been suitable for plenum cable insulation applications due to their high dielectric constant. In one aspect, the present disclosure concerns the use of engineering thermoplastics in wire insulation in plenum communication cables. A combination of processing and selection of blowing agents allow one to foam engineering thermoplastics (such as polycarbonate and its copolymers, polyether imide and its copolymers, and polyphenylene oxide, its copolymer and with elastomer blends) to produce foamed insulation products. The disclosed methodology makes engineering thermoplastics suitable for use in communication cable insulation. Extruded foamed engineering thermoplastic insulation satisfies electrical requirements, mechanical performance requirements, processability requirements, the flame and smoke requirements of plenum rated cables.

Engineering thermoplastics include polycarbonates (PC), polysulfone (PSU), polyethersulfone, polyarylsulfones (e.g., polybiphenylether sulfone (PPSU), polyphenylsulfone (PPS), polyarylether sulfone (PES)), polyphenylene, polyimide, polyaryletherketone (e.g., polyetheretherketone (PEEK)), and poly(arylene ether), polyolefins, polystyrenes, polyesters, polyamides, polyphenylene sulfides, and polyarylene sulfides. Such polymers are available for purchase on a global basis. Specific materials include LEXAN™ copolymer and blends, branched polycarbonate (PC) and blends, polyphenylene ether (PPE)-elastomer blends and PPE-elastomer blends, polyetherimide (PEI) resins such as ULTEM™ and blends, PEI-siloxane resins such as SILTEM™ and blends, polyether ether ketone (PEEK) and blends, polyphenylene sulfide (PPS) and blends, polyethersulfone (PES) and blends, SILTEM™ and LEXAN™ FST blends, SILTEM™ and PEEK blends, SILTEM™ and PPS blends, SILTEM™ and PPSU blends, and SILTEM™ and PES blends. For example, the engineering thermoplastics can comprise at least one of polyphenylene ether (PPE)-elastomer blends and PPE-elastomer blends. The engineering thermoplastic can comprise at least one of NORYL™ resins from SABIC Innovative Plastics, XYRON™ resins from Asahi Kasei Chemicals Corporation, IUPIACE™ resins from Mitsubishi, LEMALLOY™ resins from Mitsubishi, polyphenyl ether resins from Bluestar, ACNOR™ resins from Aquafil Technopolymers, ASHLENE™ resins from Ashley Polymers, and VESTORAN™ resins from Evonik Degussa.

The engineering thermoplastic can be foamed for use in this application. If foaming of the layers is desired, the wire can be preheated to a temperature above ambient, and up to the glass transition or melt temperature of the particular coating material being foamed. The process conditions and temperature profile used for foaming depends on the material used for each layer. Ideally, foaming uses a balance of the selection of a blowing agent, such as a chemical blowing agent (CBA) (including the content of active agent, dispersability of the chemical blowing agent in matrix, and process temperature mapping of the chemical blowing agent, and engineering thermoplastic to foam) or a physical blowing agent (PBA), temperature profile of extruder, preheating of the wire and cooling profile, and specific materials used. The first and/or second layer can be foamed during the first and/or second extrusion.

The temperature profile (feed zone to rear die) for foaming is mainly dependent on the engineering thermoplastics and the thermal decomposition behavior of the specific chemical blowing agent adopted. Foaming can be used to lower the dielectric constant of engineering thermoplastics to the range that is required by plenum cable insulation applications, as well as to reduce the cost of the material. The method taught herein, allows use of engineering thermoplastics, which have traditionally also shown poor foamability in the past, for wire insulation extrusion.

The first coating layer and/or the second coating layer can be expanded into a foam during extrusion. A foamed layer, refers to a cellular like structure, desirably where the foamed layer has a substantially uniform void cell distribution due to the blend of foam generating additives, such as foaming agents and/or nucleating agents. A blowing agent can be added to the first coating layer material and/or second coating layer material prior to extrusion to maximize the number of voids formed and minimize the size of the voids. Desirably, a blowing agent can be added to the first coating layer material. Optionally, a blowing agent is only added to the first coating layer material. The amount of void space in the first coating layer and/or second coating layer can be zero, greater than 10%, greater than 20%, or greater than 30%. For example, the amount of void space in the first coating layer can be greater than 10%, greater than 20%, or greater than 30%. For example, the amount of void space in the second coating layer can be less than 5%, or less than 3%, or zero.

The nucleating agent can comprise at least one of boron nitride, magnesium, calcium, barium, zinc, lead oxide, lead carbonate, alumina, silica gel, titanium dioxide, and combinations thereof.

The blowing agent can comprise at least one of a chemical blowing agent and a physical blowing agent. The blowing agent can include at least one of nitrogen, carbon dioxide, argon, neon, methylene chloride, low-boiling hydrocarbons (e.g., having a boiling point of less than 50° C., such as pentane); e.g., at least one of nitrogen, carbon dioxide, argon, neon, and methylene chloride. For example, the blowing agent can comprise carbon dioxide, such as a first coating layer comprising polyethylene and using carbon dioxide as the blowing agent.

The blowing agent(s) can be of the decomposition type (evolve a gas, such as carbon dioxide (CO₂), nitrogen (N₂), and/or ammonia gas) upon chemical decomposition, and/or an evaporation type (which vaporizes without chemical reaction). Possible blowing agents include, but are not limited to, carbon dioxide, sodium bicarbonate, azide compounds, ammonium carbonate, ammonium nitrite, monosodium citrate, citric acid, 5-phenyl-3,6-dihydro-2H-1,3,4-oxadiazin-2-one, 5-phenyl-1H-Tetrazole, light metals which evolve hydrogen upon reaction with water, chlorinated hydrocarbons, chlorofluorocarbons, azodicarbonamide, N,N′dinitrosopentamethylenetetramine, trichloromonofluoromethane, trichlorotrifluoroethane, methylene chloride, organic carboxylic acids (such as formic acid, acetic acid, oxalic acid, ricinoleic acid and the like), pentane, butane, ethanol, acetone and so forth, as well as combinations comprising at least one of the foregoing. Examples of some commercial blowing agents include, but are not limited to, 6257 ID Endo Foam 35 XFC, 5767 ID Endo Foam IOOFC, 8812 ID Exo Foam 80, 8861 ID 25, 6851 ID 35 MFC, 6400 ID 35 NA, 6295 ID 70 XFC, 6265 ID 70 MFC, 7800 ID 70 NA, 6905 ID 90 NA, 6906 ID 90 NA FC, 6258 ID 100 XFC 100, 6836 ID 130 MFC, 6950 ID 40 EEFC, 6952 ID 40 EEXFC, 6112 ID 70 EEFC, 6833 ID 70 EEFC, 8085 ID 70 EEMFC, 7236 ID Foam EEFC, 7284 ID 80 2300 EXO, 7285 OD 80 2400 EXO, 71531 ID 100 MFC EXO, 8016 ID 120 EXO, 6831 ID 135 EXO, Palmarole EXP 141/92B, Palmarole BA.K2.S1, Palmarole BA.F4.S, Palmarole BA.F2.S, Palmarole BA.K5.S, Palmarole BA.F4.E.MG, Palmarole BA.K3.EF, Palmarole BA.M4.E, Palmarole MB.BA10, Palmarole MB.BA.13, Palmarole MB.BA.15, Palmarole MB.BA.16, Palmarole MB.BA.18, Palmarole BA.M7.E, Palmarole BA.K2.S1, Palmarole BA.F4.S, Palmarole BA.K4.S, Palmarole BA.F2.S, Palmarole BA.K3.EF, Palmarole BA.K4.C, and Bergen International Foamazol™ series 32, 40, 41, 43, 50, 57, 60, 61, 62, 63, 70, 71, 72, 73, 73S, 90, 91, 92, 93, 94, 95, 96, as well as XO-255, XO-256, XO-286, XO-330, XO-339, XO-355, XO-379, XO-385, XO-423, XOP-301, XOP-305 and XOP-341. The amount of chemical blowing agent employed is dependent upon the process, processing conditions and the specific polymeric materials.

The temperature profile should take the thermal decomposition behavior of the CBA and conventional processing temperature of engineering thermoplastic into account. It is important to keep the CBA from releasing gas before the CBA is transported to the plasticizing zone of the screw and to use a temperature profile that makes the CBA decompose, as fully as possible, e.g., only in plasticizing and metering zone of screw. The temperature can also affect solubility of released gas from the CBA in the matrix polymer.

If a physical blowing agent (PBA) is used, the dissolution of PBA in the matrix could affect the viscosity of the pure matrix and the temperature setup should be adjusted as well to adapt to such a change. Therefore, the temperature setup for a foam extrusion is different than a conventional setup for a solid/unfoamed extrusion.

The amount of chemical blowing agent can be 0.01 wt. % to 10 wt. %, or, specifically, 0.05 wt. % to 5 wt. %, or, more specifically, 0.2 wt. % to 1 wt. %, wherein the weight percent is based upon a total weight of the layer comprising the blowing agent. Multiple blowing agents can be used to achieve desired foaming. Optionally, 0.1 wt. % to 5 wt. %, or, specifically, 0.15 wt. % to 3 wt. % of an additional, different blowing agent(s), or, specifically, 0.2 wt. % to 1 wt. % of additional blowing agent(s), can be used, based upon the total weight of the layer comprising the blowing agents. If a physical blowing agent is used, the amount of physical blowing agent can be 0.005 wt. % to 0.1 wt. %, e.g., 0.01 wt. % to 0.05 wt. %, or 0.02 wt. %, based upon a total weight of the layer comprising the blowing agent.

The first and/or second coating layer can comprise up to 100 wt. % foamed thermoplastic polymeric material or greater than 0 wt. % to about 100 wt. % of the foamed thermoplastic polymeric material, based on the total weight of the coating layer comprising the foamed thermoplastic polymeric material. For example, the costing layer can comprise 2 to 80 wt. %, or 5 to 50 wt. % or 10 to 30 wt. % of foamed thermoplastic material.

The foamed material can be with or without a skin; the skin being a solid outer layer on the foamed insulation which may or may not be made of the same material as the foam. For a communication cables with several twisted insulation pairs, each insulation or each pair can use the same or different materials; and each insulation or each pair can be either solid or foamed or multilayer. For example, for plenum communication cables with four insulation pairs, 1 insulation pair can use material A and the other three pairs can use material B. Or two pairs can use material A and the other 2 pairs can use material B. Configurations include mixtures of solid, foam, and multilayer formulations.

Table 1 compares some key properties of SILTEM™, SILTEM™ and PEEK blends, ULTEM™, and LEXAN™ copolymer with FEP, indicating those materials have overcome the undesired problems associated with FEP as insulation materials for plenum rated communication cables. SILTEM™, SILTEM™ and PEEK blends, ULTEM™, and LEXAN™ copolymer offer a lower system cost due to their lower specific gravity than FEP. They are less corrosive during cable processing. Furthermore, they contain less or no halogen content and therefore generate less toxic smoke than FEP.

TABLE 1
Comparison of key properties indicating SILTEM ™, SILTEM ™ and PEEK blends,
ULTEM ™, and LEXAN ™ copolymers. “1” is designated best performance and
“4” as worst performance.

| | Polymer | | | | | |
|---|---|---|---|---|---|---|
| | | SILTEM ™ | | LEXAN ™ | FLEX | |
| Property | SILTEM ™ | PEEK | ULTEM ™ | copolymer | NORYL ™ | FEP |
| Halogen Free | 1 | 1 | 1 | 1 or 2 | 1 | 4 |
| Flexibility | 2 | 2 | 3 | 3 | 2 | 1 |
| Elongation | 2 | 1 | 3 | 2 | 2 | 1 |
| Specific Gravity | 1 | 1 | 1 | 1 | 1 | 4 |
| Abrasion | 3 | 1 | 1 | 1 | 1 or 2 | 4 |
| FR (LOI) | 2 | 2 | 2 | 3 | 3 | 1 |
| UL VW1 | 1 | 1 | 1 | 1 | 1 | 1 |
| Dielectric | 3 | 3 | 3 | 3 | 3 | 1 |
| Constant (Solid) | | | | | | |
| Dielectric | 1 | 1 | 1 | 1 | 1 | 1 |
| Constant (50% | | | | | | |
| Foamed) | | | | | | |
| Smoke Density | 1 | 1 | 1 | 1 | 1 | 1 |
| Smoke Toxicity | 1 | 1 | 1 | 1 or 2 | 1 | 4 |
| Processability | 1 | 1 | 1 | 1 | 1 | 3 |

In some compositions, the polymeric material is substantially free of fluorine and contains less than 50 wt. % of other halogens. In certain embodiments, the compositions comprise less than 40 wt. %, or less than 30 wt. %, or less than 20 wt. %, or less than 10 wt. % halogens. The coatings can be halogen free.

Further, additives may be added to the compositions. The additive composition can include filler, flame retardant, impact modifier, flow modifier, antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, anti-drip agent (e.g., a PTFE-encapsulated styrene-acrylonitrile copolymer (TSAN)), or a combination comprising one or more of the foregoing. In some embodiments, the total amount of the optional additive composition (other than any impact modifier, filler, or reinforcing agent) can be 0.001 wt. % to 10.0 wt. %, or 0.01 wt. % to 5 wt. %, each based on the total weight of the thermoplastic polymeric material in the composition. Filler, impact modifier and/or reinforcing agent may be used in higher amounts, up to 20 wt. % in some embodiments.

Coated wires can be formed as described in the following table, showing the processing conditions, preheat temperature for the wire, amount of chemical blowing agent (CBA), and distance in centimeters (cm). The coating can be a polyphenylene ether-elastomer blend.

| Processing temp/C. | Preheat/C. | CBA | Distance/cm |
|---|---|---|---|
| 180/190/200/220/220/220/220 | 180 | 1.0% | 23 |
| 200/210/220/235/235/235/235 | 180 | 1.0% | 23 |
| 220/230/240/250/250/250/250 | 180 | 1.0% | 23 |
| 230/240/250/265/265/265/265 | 180 | 1.0% | 23 |
| 220/230/240/250/250/250/250 | 23 | 1.0% | 23 |
| 220/230/240/250/250/250/250 | 90 | 1.0% | 23 |
| 220/230/240/250/250/250/250 | 180 | 0.5% | 23 |
| 220/230/240/250/250/250/250 | 180 | 2.0% | 23 |
| 220/230/240/250/250/250/250 | 180 | 3.0% | 23 |
| 220/230/240/250/250/250/250 | 180 | 5.0% | 23 |
| 220/230/240/250/250/250/250 | 180 | 1.0% | 9 |
| 220/230/240/250/250/250/250 | 180 | 1.0% | 46 |
| 220/230/240/250/250/250/250 | 180 | 0.0% | 23 |

The processes disclosed herein include at least the following embodiments:

### Embodiment 1

A method of making a wire with multiple coating layers, comprising: preheating a wire to a temperature Tₚᵣₑₕₑₐₜ to form a pre-heated wire, wherein a first coating layer material has a glass transition temperature Tg¹, and wherein Tg¹≥Tₚᵣₑₕₑₐₜ; using a first extruder to coat the pre-heated wire with the first coating material to form a first coated wire; passing the first coated wire to a second extruder without active cooling of the first coated wire; coating the first coated wire with a second coating material to form a second coated wire; cooling the second coated wire; and preferably coiling the second coated wire.

### Embodiment 2

A method of making a wire with multiple coating layers, comprising: preheating a wire to a temperature Tₚᵣₑₕₑₐₜ to form a pre-heated wire; using a first extruder to coat the pre-heated wire with the first coating material to form a first coated wire; passing the first coated wire to a second extruder without storing the first coated wire, and preferably without actively cooling the first coated wire, coating the first coated wire with a second coating material to form a second coated wire; and cooling the second coated wire.

### Embodiment 3

The method of any of Embodiments 1-2, wherein the first coating material and/or the second coating material are foamed during extrusion.

### Embodiment 4

The method of Embodiment 3, wherein the amount of void space in the first coating layer and/or second coating layer is greater than or equal to 30%.

### Embodiment 5

The method of any of the preceding embodiments, wherein the first and/or second coating material is an engineering thermoplastic material.

### Embodiment 6

The method of any of the preceding embodiments, wherein the first layer is less than or equal to 0.20 mm thick.

### Embodiment 7

The method of any of the preceding embodiments, wherein the second layer is 0.30 mm thick.

### Embodiment 8

The method of any preceding Embodiment, wherein the wire is pulled by a retractor to through the first and second extruders at a speed from 10 m/min to 500 m/min.

### Embodiment 9

The method of any of the preceding embodiments, wherein the cooling is performed using at least one of a water bath, water spray, and air jets.

### Embodiment 10

The method of Embodiment 9, wherein the temperature of the water used for cooling is from 5° C. to 60° C.

### Embodiment 11

The method of any of the preceding embodiments, wherein the first and/or second coating material, independently, at least one of polycarbonates, polyphenylene ether, elastomer blends, polyetherimide, polyethylene, thermoplastic engineering elastomers, and engineering thermoplastic materials.

### Embodiment 12

The method of any preceding embodiment, wherein the first coated wire moves directly to the second extruder.

### Embodiment 13

The method of any of the preceding embodiments, wherein the first coated wire is not actively cooled.

### Embodiment 14

The method of any of the preceding embodiments, wherein the second coating is applied before the first coated wire is spooled.

### Embodiment 15

A wire formed by the method of any of the preceding embodiments.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method of making a wire with multiple coating layers, comprising:
preheating a wire to a temperature Tₚᵣₑₕₑₐₜ to form a pre-heated wire, wherein a first coating layer material has a glass transition temperature Tg¹, and wherein Tg¹≥Tₚᵣₑₕₑₐₜ;
using a first extruder to coat the pre-heated wire with the first coating material to form a first coated wire;
passing the first coated wire to a second extruder without active cooling of the first coated wire,
coating the first coated wire with a second coating material to form a second coated wire; and
cooling the second coated wire.

2. A method of making a wire with multiple coating layers, comprising:
preheating a wire to a temperature Tₚᵣₑₕₑₐₜ to form a pre-heated wire;
using a first extruder to coat the pre-heated wire with the first coating material to form a first coated wire;
passing the first coated wire to a second extruder without storing the first coated wire,
coating the first coated wire with a second coating material to form a second coated wire; and
cooling the second coated wire.

3. The method of claim 1, wherein the first coating material and/or the second coating material are foamed during extrusion.

4. The method of claim 3, wherein the amount of void space in the first coating layer and/or second coating layer is greater than or equal to 30%.

5. The method of claim 1, wherein the first and/or second coating material, independently, comprises at least one of polycarbonates, polyphenylene ether, elastomer blends, polyetherimide, polyethylene, thermoplastic engineering elastomers, and engineering thermoplastic materials.

6. The method of claim 1, wherein the first and/or second coating material is an engineering thermoplastic material.

7. The method of claim 1, wherein the first layer is less than or equal to 0.20 mm thick.

8. The method of claim 1, wherein the second layer is 0.30 mm thick.

9. The method of claim 1, wherein the wire is pulled by a retractor to through the first and second extruders at a speed from 10 m/min to 500 m/min.

10. The method of claim 1, wherein the cooling is performed using at least one of a water bath, water spray, and air jets.

11. The method of claim 10, wherein the temperature of the water used for cooling is from 5° C. to 60° C.

12. The method of claim 1, wherein the second coating is applied before the first coated wire is spooled.

13. A wire formed by the method of claim 1.

14. The method of claim 2, wherein the wire is pulled by a retractor to through the first and second extruders at a speed from 10 m/min to 500 m/min.

15. The method of claim 2, wherein the cooling is performed using at least one of a water bath, water spray, and air jets, and wherein the temperature of the water used for cooling is from 5° C. to 60° C.

16. A method of making a wire with multiple coating layers, comprising:
preheating a wire to a temperature Tₚᵣₑₕₑₐₜ to form a pre-heated wire;
using a first extruder to coat the pre-heated wire with the first coating material to form a first coated wire;
passing the first coated wire to a second extruder without storing the first coated wire,
coating the first coated wire with a second coating material to form a second coated wire; and
cooling the second coated wire;
wherein the temperature of the water used for cooling is from 5° C. to 60° C.; and
wherein the wire is pulled by a retractor to through the first and second extruders at a speed from 10 m/min to 500 m/min.
